(19) United States
(12) Patent Application Publication
(10) Pub. No.: US 2001/0050619 A1
(43) Pub. Date: Dec. 13, 2001

(54) Remote activation system for marine appliances

(76) Inventors: Ronald E. Wiggerman, McHenry, IL (US); Rudolph P. Guzik, Frankfort, IL (US); Allan E. Boleslawski, Bear, DE (US)

Correspondence Address: GARDNER, CARTON & DOUGLAS, 321 N. CLARK STREET, SUITE 3400, CHICAGO, IL, 60610, US

(21) Appl. No.: 09/777,804

(22) Filed: Feb. 6, 2001

Related U.S. Application Data
(60) Provisional application No. 60/180,758, filed on Feb. 7, 2000.

(51) Int. Cl. G08B 1/08

(52) U.S. Cl. 340/825.72; 340/825.69; 340/539

(57) ABSTRACT

A system for remote activation of multiple marine electronic appliances, whereby all the appliances within the system may be activated and deactivated at once, or whereby different appliances within the system may be remotely activated and deactivated. The system includes a receiver connected to the circuit for an appliance and a transmitter set to transmit signals, which are received by the receiver and activate or deactivate the connected appliance. The appliances include boat lights, dock lights, pier lights and the like.

### RELATED APPLICATION

This application claims the benefit of U.S. Provisional Application No. 60/180,758, filed on Feb. 7, 2000.

### FIELD OF THE INVENTION

This invention relates to appliance activation systems and, more specifically to the activation and deactivation of appliances such as but not limited to lights on a boat or a dock by use of a remote control unit.

### BACKGROUND OF THE INVENTION

After docking a boat at night, all lights are turned off and a boater must then exit the boat and walk down a pier, which often has no illumination. Also, when boarding a boat in the dark, in order for a boater to turn on the lights to the cockpit or cabin, the boater must board the boat, access the controls to the boat lights and turn the lights on. Depending on the configuration and type of the boat, it may take a considerable amount of time to access the necessary areas of the boat, and subject the boater to conditions that are unsafe because of inadequate lighting. For example, a boater may have to remove boat covers and the like, in the dark before illumination of the boat is possible. Moreover, it is currently not possible to turn on dock lights remotely, such as when approaching the dock either from land or by boat. This can make it difficult to approach and board the boat from land or to dock the boat as it approaches the dock in the water.

Additionally, often dock space is rented, or multiple persons use the same dock space. It is currently not possible for multiple persons on different boats to turn on dock lights remotely.

Thus, it would be useful to have a means for remotely activating and deactivating appliances such as but not limited to lights on a boat, dock or other marine location. It would also be useful to have a system for remote activation of marine appliances whereby the same appliance, for instance, lights, could be turned on by persons on different boats.

### SUMMARY OF THE INVENTION

Accordingly, it is an object of the invention to provide a system for activating boating appliances such as boat and dock lights wherein the appliances may be activated and deactivated from remote locations.

It is yet another object to provide a transmitter/receiver system whereby a single receiver may be activated by multiple transmitters.

The above and additional objects are realized in the present invention that provides a means for remote activation of multiple marine electronic appliances, whereby all the appliances within the system may be activated and deactivated at once, or whereby different appliances within the system may be remotely activated and deactivated. The appliances include boat lights, dock lights, ignition switches and the like. Optionally, the invention provides a means for activation by persons on different boats of the same appliance, such as a dock light

### BRIEF DESCRIPTION OF THE DRAWINGS

Other objects and advantages of the invention will be apparent from the following detailed description and the accompanying drawings, in which:

FIG. 1 is an illustration of the receiver and transmitter components of the system; and

FIG. 2 is a diagram of a typical receiver/transmitter system of the invention as configured with various marine appliances.

### DETAILED DESCRIPTION OF THE PREFERRED EMBODIMENTS

While the invention is susceptible to various modifications and alternative forms, certain preferred embodiments are shown by way or example in the drawings and will herein be described in detail. It should be understood, however, that it is not intended to limit the invention to the particular forms described, but to the contrary, the invention is intended to cover all modifications and alternatives falling within the spirit and scope of the invention as defined by the appended claims.

The remote marine light system of the invention allows a boater to have cockpit lights after the main lights have been turned off and also lights that can be turned on and off from a distance, such as pier or dock lights, or any other lights within the distance range of the transmitter.

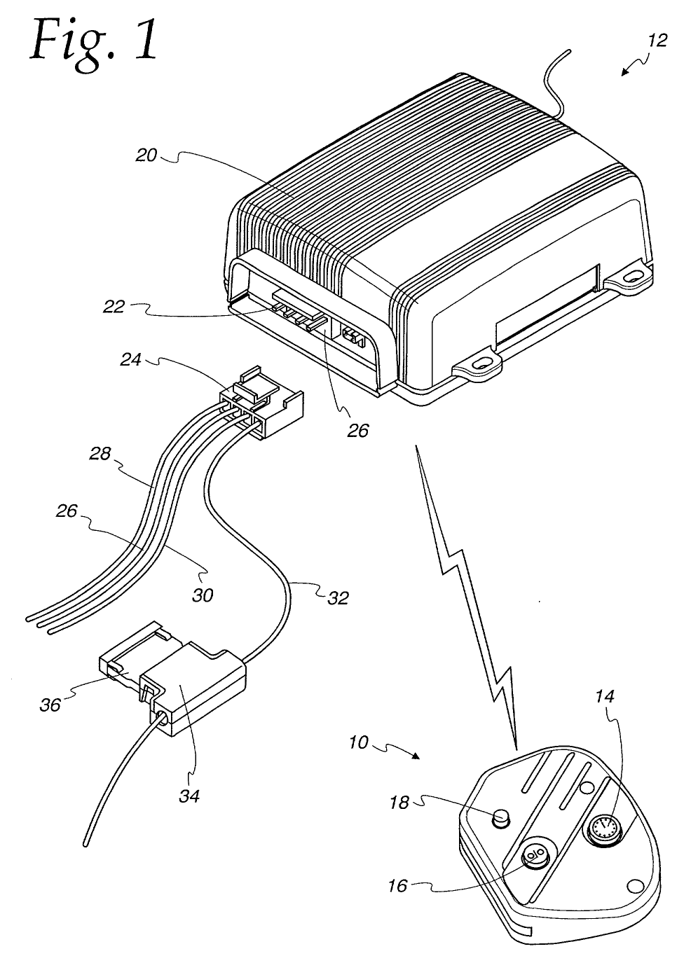

Referring now to FIG. 1, in one preferred embodiment, the present invention uses a transmitter 10 and at least one receiver 12. According to a preferred embodiment, the transmitter transmits radio frequencies (RF), although electronic frequencies other than radio frequency may also be transmitted. In addition, the transmitters and receiver may use light waves, such as but not limited to infrared light, or ultrasonic frequencies to perform the activation/deactivation function. There are many types of commercially available receiver/transmitter systems that are suitable for use in the invention, and these are commonly known to those skilled in the art.

The preferred embodiment utilizes radio frequency transmissions, which are transmitted by the transmitter 10. In the preferred embodiment illustrated in FIG. 1, the transmitter is powered by a 12-volt replaceable or rechargeable battery, and comprises a timer 14, a power switch 16 and an indicator light 18. The electrical components of the transmitter are contained within a housing, which is preferably waterproof.

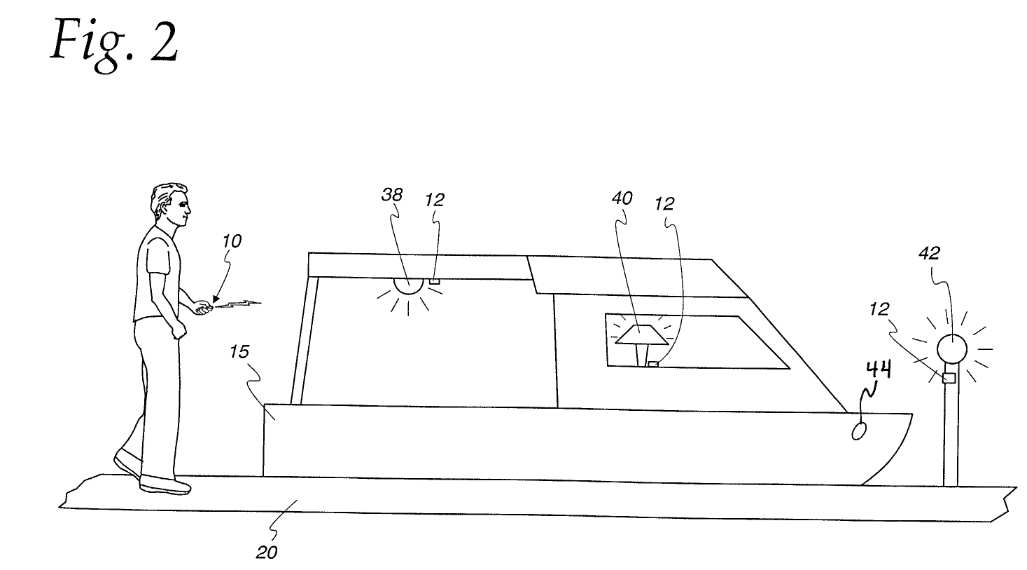

Referring now to the receiver 12 of the invention as illustrated in FIG. 1, each receiver 12 comprises a housing 20, a jumper connection 22 and a jumper cable 24. The housing has an opening 26, through which the jumper connection 22 is reached. The jumper cable 24 has four attached wires, 26, 28, 30 and 32, respectively. Wires 26 and 28 are connected so as to complete a circuit for a marine appliance, such as but not limited to a light. Wire 30 is attached to a fuse mount 34, into which a fuse 36 is replaceably inserted. In the preferred embodiment and wires 30 and 32 are connected to the positive and negative ends of a power supply respectively, with wire 30 further having a fuse 34 intermediary to the positive terminal of a power supply. The receiver 12 is powered by the power supply, which in the preferred embodiment may be any standard 12V power supply, a number of which are commercially available. Also in this preferred embodiment, the fuse 34 is a 10 amp automobile fuse, which may be readily obtained and easily replaced. In the preferred embodiment, appliances drawing 5 amps or less of current may be controlled using the remote control system of the invention, although the components may be variously configured or modified to control appliances having a greater current draw. The receiver 12 is mounted near or on the appliance, for instance, lights 38 and 40 as illustrated in FIG. 2.

The transmitters 10 of the invention may preferably be carried on a floatable key chain. In the preferred embodiment illustrated herein, the transmitter of the invention will be effective in the range of about 50 feet or less; by reconfiguring the componentry in accordance with methods known in the art, such as to increase transmitter power, this distance may be increased

At least one receiver 12 is installed on a boat 15, or variously, a pier lighting system 42 or other marine appliance. Optionally, the receiver may be programmed to receive signals from multiple transmitters.

The housings for the receiver and transmitter of the invention are preferably made of plastic, metal, polymers or any other suitable material which is impermeable to water and which may be molded into the shapes needed for the housings. Additionally, the transmitter may have a key chain attached.

In an alternative embodiment illustrated in FIG. 2, the deck lights 38 and docking lights 44 are configured to turn on when the boat electrical system is remotely activated. The deck lights 38 and docking lights 44 should provide sufficient light for a boater to board onto the boat 14 at night or under other low light conditions. In yet another preferred embodiment of the invention using the remote system to control boat lights, the lighting system on the boat 15 comprises several lights on a single series circuit, with the receiver 12 of the invention wired into the circuit. Thus, when activated, the transmitter of the invention will activate all the lights in the circuit. Optionally, a receiver may also control a cabin light 40 or a light fixture 42 on a dock 20 or other pedestrian walkway.

Referring now to FIGS. 1 and 2, in operation, a boater carries the transmitter 10. When the boater approaches the boat 14 or the dock 20, the boater presses the power switch 16 on the transmitter 10, which activates the transmitter 10 to send a signal to the corresponding receiver 12, which is set to receive the particular frequency or the transmitter. Additionally, when the power switch 16 on the transmitter 10 is depressed, the indicator light 18 activates to tell the operator that the transmitter 10 is transmitting. When the receiver 12 receives the signal, it closes the circuit between wires 26 and 28 which turns on the appliances to which it is attached, such as deck lights 38 and docking lights 40.

Optionally, the timer 14 may be activated to program the lights to turn off the lights after a fixed amount of time, for instance in two minutes. If, after activating the timer 14 the boat operator wished to deactivate the lights of the system sooner than the programmed time, the boat operator need only depress the power switch 16.

The present invention may also be configured with a second transmitter which may be used, for example, by a different boater to activate the pier lighting system 42, as illustrated in FIG. 2. Thus, when the transmitter 10 is activated or pier lights 42 are turned on. The boater can then activate or pier lights 42 when approaching the pier from land or water. Alternatively, the invention may be configured with a transmitter capable of transmitting at different frequencies and different receivers, adjusted to receive at different frequencies so the transmitter may be used to selectively activate and deactivate a plurality of different appliances. Various commercially available methods and components may suffice for use in the invention.

Thus, what is provided is a system for remote activation of marine appliances such as boat or pier lights, wherein the system comprises at least one transmitter and at least one receiver programmed to receive signals from the transmitter, wherein the receiver is wired within the circuit of at least one marine appliance and activates the appliance when the transmitter is activated.

What is claimed is:

1. A remote marine appliance activation system comprising:
at least one appliance for use on a boat;
at least one receiver connected to at least a portion of the lighting system, and
at least one transmitter having a power switch, wherein the transmitter sends a signal to a receiver from a remote location when the power switch is depressed, and
wherein the receiver activates or deactivates the portion of the appliance system connected thereto to turn on or off the appliances when a signal is received from transmitter.

2. The system of claim 1, wherein the signal sent by the transmitter and received by the receiver is one of said different frequencies.

3. The system of claim 1, wherein the transmitter sends signals of different frequencies to at least two receivers within the system, wherein each receiver is set to receive a single frequency.

4. The system of claim 1, wherein the transmitter includes a timer.

5. The system of claim 4, wherein the appliance is at least one light and the transmitter includes an indicator light, wherein the indicator light activates upon activation of the power switch or timer.

6. The transmitter of claim 5, wherein the transmitter is waterproof and floats.

7. The system of claim 5 wherein the system operates remotely within a distance of about 50 feet and further wherein an appliance draws 5 amps of current or less.

8. A marine light system comprising:
at least one marine light having an associated receiver which can respond to a radio frequency signal to connect the or disconnect the light from an electrical circuit, the light being located on a boat and optionally also on a dock; and
a remote control transmitter unit operable to transmit at least one radio frequency signals for controlling the operation of at least one marine light;
wherein each remote control transmitter is arranged to transmit a radio frequency signal for each receiver in the system.

9. The system of claim 8 wherein the remote control transmitter unit further comprises a timer, wherein the timer may be used to activate the light for a preprogrammed period of time, after which the light deactivates.

10. The system of claim 9 wherein the system operates remotely within a distance of about 50 feet and further wherein a light draws 5 amps of current or less.

11. A marine lighting system comprising a first light system with at least one light for use on a marine dock or pier;
a first receiver connected to at least a portion of the first lighting system;
a second light system with at least one light for use on a boat;
a second receiver mounted on the boat and connected to at least a portion of the second light system;
at least one remote transmitter wherein the transmitter sends a signal to the first and second receivers from a remote location, and
Wherein the receiver activates or deactivates the portion of the first and second lighting system connected thereto to light the marine dock or pier when a signal is received from the transmitter.
